(19) United States
(12) Patent Application Publication
(10) Pub. No.: US 2010/0274728 A1
(43) Pub. Date: Oct. 28, 2010

(54) Video Shipment Monitoring

(75) Inventor: Neil Kugelman, Woodmere, NY (US)

Correspondence Address: MOAZZAM & ASSOCIATES, LLC, 7601 LEWINSVILLE ROAD, SUITE 304, MCLEAN, VA, 22102, US

(73) Assignee: REFINEMENT SERVICES, LLC, Lynbrook, NY (US)

(21) Appl. No.: 12/429,257

(22) Filed: Apr. 24, 2009

(51) Int. Cl. G06Q 30/00; G06Q 10/00; G06F 17/40; G06Q 50/00; H04N 7/18

(52) U.S. Cl. 705/80; 705/28; 705/26; 705/30; 707/E17.028; 707/E17.044; 348/61

(57) ABSTRACT

The present disclosure describes systems and methods for conducting remote business transactions between a client and an entrepreneur that include generating records including video verification of some or all aspects of the remote business transaction. According to one aspect of the system, the client sends a plurality of items to the recipient. Upon reception of these items, the recipient creates an inventory of the items, including video verification of the inventory. Such video verification is included in a stored electronic record of the remote business transaction. Via any suitable telecommunications network, this electronic record, including the video verification of the transmitted inventory, is accessible by the client.

### BACKGROUND OF THE INVENTION

1. Field of the Invention

The present invention relates to the field of records management. In particular, the present invention relates to a system of generating records of remote business transactions which promote a high degree of transparency in the transaction.

2. Background of the Invention

Conducting business remotely from customers presents opportunities for entrepreneurs to easily expand into new markets. One common conduit for conducting remote business transactions is the internet (“e-commerce”). However, especially for businesses that require exchanges of goods, internet business transactions present formidable challenges for both entrepreneurs and their clients compared to face-to-face business transactions. Take as an example an internet business transaction that requires the client to ship personal property to the entrepreneur. Such a shipment entails greater risks and greater obstacles for both parties compared to if the client and entrepreneur were able to perform the transaction face-to-face. For example, because the entrepreneur and the client may not be based in the same locality, they may not be well known to each other and thus their respective identities may be easier to conceal. It may be difficult for the client to find reliable information on the entrepreneur's reputation. Because it is cheaper and quicker to set up a website and send out bulk solicitations over the internet than it is to establish a local bricks-and-mortar business with local contacts, the internet attracts fraudulent enterprises. Furthermore, the entrepreneur and any of his or her employees are temporarily in possession of the client's shipped personal property shipped in the absence of the client. Additionally, having to ship the personal property means that the internet business transaction may take place over an extended period of time, during which the client may become uncertain as to exactly what personal property was shipped to the entrepreneur. Having engaged in such an unmonitored transaction with the entrepreneur, the client may be tempted to blame the entrepreneur later if some adverse event involving the shipped personal property comes to pass, such as if the personal property is damaged or is lost. Finally, clients not familiar with the internet may be mystified or confused by the technology involved.

Such risks and obstacles become magnified in the event the shipped personal property includes “one of a kind” items like jewelry or precious metals because, for example, items of similar superficial appearance may not be equivalent (unlike, for the most part, mass produced commodities) and thus may vary widely in monetary value. A potential client may worry that an unscrupulous entrepreneur could return a less valuable jewel for the one originally shipped since the transaction is unmonitored. Such risks, and others, may make clients reluctant to do business with an entrepreneur over the internet. Third parties, like an insurance company which has to pay out a claim on a missing jewel involved in such a transaction, also have incentives to reduce the unmonitored nature of internet business transactions.

Entrepreneurs have undertaken efforts to increase the transparency of their internet business transactions to allay some of these concerns. For example, entrepreneurs may introduce third party enterprises not otherwise involved in the transaction simply for processing payments. Examples of such third party enterprises are PAYPAL and GOOGLE CHECKOUT. Theoretically, such a third party enterprise represents a neutral party to which complaints from either party about the remote business transaction can be made. Another common feature of internet business transactions to make them more transparent to the client is inclusion of customer account pages on enterprise websites for updates regarding the current state of the remote business transaction. Being aware of the state of the remote business transaction they are involved in may allay some of the anxiety a client feels by doing business remotely. Finally, use of tracking numbers in standardized shipping containers for shipping goods allows the client and the enterprise to track any goods shipped between them to determine when and if they were delivered.

However, even with these common features, the unmonitored nature of much of internet business transactions remains and thus entrepreneurs and their clients may be wary to conduct important business transactions over the internet. Consider as an example a typical business model for an online gold-purchase business. The gold-purchase business establishes a website through which a client can request an online account. When the client wishes to sell gold to the gold-purchase business, the client requests a shipping envelope via the online account. The gold-purchase business then sends a shipping envelope to the client, having noted the tracking number of the shipping envelope as a transaction ID. The client then sends the gold-purchase business a plurality of jewelry. The gold-purchase business then determines the monetary value through standard weighing and assaying techniques and a current market price for gold. The gold-purchase business, by noting the transaction ID of the received shipping envelope, then updates the associated account with an offer price for the received plurality of jewelry. The gold-purchase business issues a check for the offer price to the client, the offer price typically a fixed percentage of the market value of the plurality of jewelry. If the client cashes the check, the remote business transaction is completed. The client otherwise returns the check and the jewelry is returned to him or her.

Such a procedure increases the transparency of the remote business transaction compared to if it was conducted without any documentation whatsoever, but it still represents a significant investment of trust for such a client to mail a possibly unknown enterprise valuable jewelry. In particular, the unmonitored nature of the temporary possession by the gold-purchase business of the client's jewelry creates uncertainties in the transaction that could potentially be exploited by either party. For example, without a clear, verifiable record of what was received, an unscrupulous gold-purchase business could substitute a less valuable item of jewelry among the items returned to the client. On the other hand, a client uncertain about what precisely they sent may falsely claim such a substitution has taken place when they inspect returned jewelry. Beyond the question of what items precisely were sent to and returned by the gold-purchase business, potential for fraud or doubt also occur in the assaying of the jewelry, as this is unmonitored in this remote business transaction, or any other aspect of the transaction by which the gold-purchase business produces an offer price for the client.

Thus, there is a need for systems and methods to increase the transparency of remote business transactions by providing clear, inconvertible records of many aspects of the remote business transaction.

### SUMMARY OF THE INVENTION

The present invention discloses systems and methods for conducting remote business transactions between a client and an enterprise that include generating records including video information regarding some or all aspects of the remote business transaction. According to the method of the present invention, the client sends one item or a plurality of items to the enterprise. Upon reception of these one or more items, the enterprise creates an inventory of the items, including video verification of the inventory. Such video verification is included in a stored electronic record of the remote business transaction. Via any suitable telecommunications network, this electronic record, including the video verification of the transmitted inventory, is accessible by the client.

In certain embodiments of the present invention, the systems and methods of the present invention are implemented in an enterprise for buying and selling precious metals and stones over the internet. According to this embodiment, via a website associated with the enterprise, a client requests an online account associated with the website. At some later time, the client, via the online account, requests a precious metals kit, including a kit identification number, from the enterprise for shipping a single or a plurality of jewelry to the enterprise. The enterprise receives the sealed precious metals kit containing the shipped jewelry from the client. A video file is created showing a return address of the sealed precious metals kit; the sealed precious metals kit being opened; the removed contents of the opened precious metals kit; and the now-empty, opened precious metals kit. An electronic transaction record is created including this video file and a plurality of measured properties of the shipped jewelry, including the precious metal or stone content of each item of the shipped jewelry; the price the enterprise will pay for each item of the shipped jewelry; and the total price the enterprise would pay for all the items of the shipped jewelry. This electronic transaction record is stored on a transaction record server. At some later time, the client logs on to their online account on the website of the enterprise for a customer view of the transaction record, including the video file. The enterprise sends a check to the address of the client for the total and the client keeps the check. Alternatively, if the client returns the check to the enterprise in some pre-determined amount of time, the shipped jewelry is returned to the client.

In another embodiment of the present invention, the invention is a method of generating a record of a remote business transaction including receiving one item or a plurality of items which is sealed, performing a video verification of an inventory of the plurality of items, estimating a monetary value of the one item or plurality of items, calculating an offer price based the monetary value of the one item or plurality of items, and grouping the video verification of the inventory of the one item or plurality of items and the offer price as the record of the remote business transaction.

In a further embodiment of the present invention, the invention is a system of generating a record of a remote business transaction involving one or item or a plurality of items which is sealed, including a video capture device, a logic on a computer readable medium to implement a monetary evaluation metric, and a transaction record server. The video capture device captures a video verification of an inventory of the one item or plurality of items. The logic to implement a monetary evaluation metric determines an offer price for the one item or plurality of items. The offer price for the one item or plurality of items and the plurality of video information are grouped as the record of the remote business transaction on the transaction record server.

### BRIEF DESCRIPTION OF THE DRAWINGS

FIG. 1 displays a flowchart of a method according to an exemplary embodiment of the present invention.

FIG. 2 displays a diagram showing the flow of goods and information between the parties and equipment of the present system, according to an exemplary embodiment of the present invention.

FIG. 3 displays a flowchart of a method of the present invention in which an enterprise buys a precious metal or stone from a client, according to an exemplary embodiment of the present invention.

FIG. 4 displays a sample screenshot of a web browser showing a login page of a website of the enterprise in which the enterprise buys precious metals from the client, according to an exemplary embodiment of the present invention.

FIG. 5A displays a sample screenshot of a web browser showing a client view of a transactions page associated with a client account in an embodiment of the present invention in which the enterprise buys precious metals from the client.

FIG. 5B displays a screenshot of a web browser showing a client view of an inventory page of a remote business transaction between the enterprise and the client, according to an exemplary embodiment of the present invention.

FIG. 6 displays a flowchart of a method according to an alternative embodiment of the present invention.

FIGS. 7A and 7B show two user cases utilizing the method of the alternative embodiment of the present invention outlined in FIG. 6, according to exemplary embodiments of the present invention.

FIGS. 8A and 8B show examples of the use of a video monitoring system, according to an exemplary embodiment of the present invention, with an automated teller machine (ATM).

### DETAILED DESCRIPTION OF THE INVENTION

The present invention discloses systems and methods for conducting remote business transactions between a client and an entrepreneur that include generating records including video verification of some or all aspects of the remote business transaction. According to a method of the present invention, the client sends an item or a plurality of items to the entrepreneur. Upon reception of these items, the entrepreneur creates an inventory of the items, including video verification of the inventory. Such video verification is included in a stored electronic record of the remote business transaction. Via any suitable telecommunications network, this electronic record, including the video verification of the transmitted inventory, is accessible by the client and any other authorized party.

In one embodiment of the present invention, the system and method of the present invention is implemented in an enterprise for buying and selling precious metals or stones over the internet. According to this embodiment, via a website associated with the enterprise, a client requests an online account associated with the website. At some later time, the client, via the online account, requests a precious metals kit, including a kit identification number, from the enterprise for shipping a plurality of jewelry to the enterprise. The enterprise receives the sealed precious metals kit containing the shipped jewelry from the client. A video file is created showing a return address of the sealed precious metals kit; the sealed precious metals kit being opened; the contents of the opened precious metals kit; and the now-empty, opened precious metals kit. An electronic transaction record is created including this video file and a plurality of measured properties of the shipped jewelry, including the precious metal content of each item of the shipped jewelry; the price the enterprise will pay for each item of the shipped jewelry; and the total price the enterprise would pay for all the items of the shipped jewelry. This electronic transaction record is stored on a transaction record server. At some later time, the client logs on to their online account on the website of the enterprise for a customer view of the transaction record, including the video file. The enterprise sends a check to the address of the client for the total and if the client returns the check to the enterprise in some pre-determined amount of time, the shipped jewelry is returned to the client.

As used herein and throughout this disclosure, a “remote business transaction” refers to any business transaction in which the financially interested parties to the transaction are geographically removed from one another.

As used herein and throughout this disclosure, “precious metals” refer to any metals publicly traded for their high monetary value. Examples of such precious metals include gold, silver, and platinum. It should be noted that the examples presented in this disclosure make use of “precious metal” but the present invention is not limited to such items, and may be used equally as well for precious stones (diamonds, emeralds, etc.) or any other item having value which is shipped between two parties. One having ordinary skill in the art would recognize the scope of the present invention as not being limited to precious metals but being that of any shipped item of value between two or more parties, whatever the item may be. The specific example of “precious metals” is being used herein and throughout this disclosure only for sake of simplicity. The reader of this disclosure should substitute the phrase and understanding of “any item of value” wherever the phrase “precious metal” is found throughout this disclosure.

As used herein and throughout this disclosure, “jewelry” refers to any item that contains some measurable quantity of a precious metal or stone.

As used herein and throughout this disclosure, “video information” refers to dynamic, continuous visual information captured by any suitable video device in any suitable form. Such suitable devices include camcorders, security cameras, web-cams, cameras, etc. and such suitable forms include .avi files, m-peg files, VHS, etc.

As used herein and throughout this disclosure, a “stamp” of a plurality of video information refers to a piece of data displayed along with the visual information of the plurality of video information. One common “stamp” is the time and date at which the plurality of video information was captured.

As used herein and throughout this disclosure, a “seal” of a package refers to a device or substance employed to close a package in such a manner that the package cannot be opened without producing some change that can be noticed. Although chemical or physical devices or substances could thus be considered a seal by this definition, more sophisticated seals (for example, an electronic seal) satisfy this definition as well. Any such technique known in the art could be used as a seal.

As used herein and throughout this disclosure, “video verification of an inventory” of a plurality of items sealed in some manner includes capturing video information of the sealed items; breaking the seal; removing all the items from the sealed area in a manner such that each individual item is displayed; and demonstrating that after the removal action, there are no items left in the sealed area. In this manner, the captured, continuous video information helps to constitute a clear, inconvertible record of what was contained in the sealed area before the seal was broken.

As used herein and throughout this disclosure, a “transaction record server” refers to any networked device for storage of electronic records. Such a transaction record server accepts records for storage and responds to requests for electronic records over a network. A typical example of such a transaction record server is a dedicated computer running database server software, such as MySQL.

As used herein and throughout this disclosure, for any remote business transaction between a client and an enterprise, “third party information” refers to information furnished by neither the client nor the enterprise.

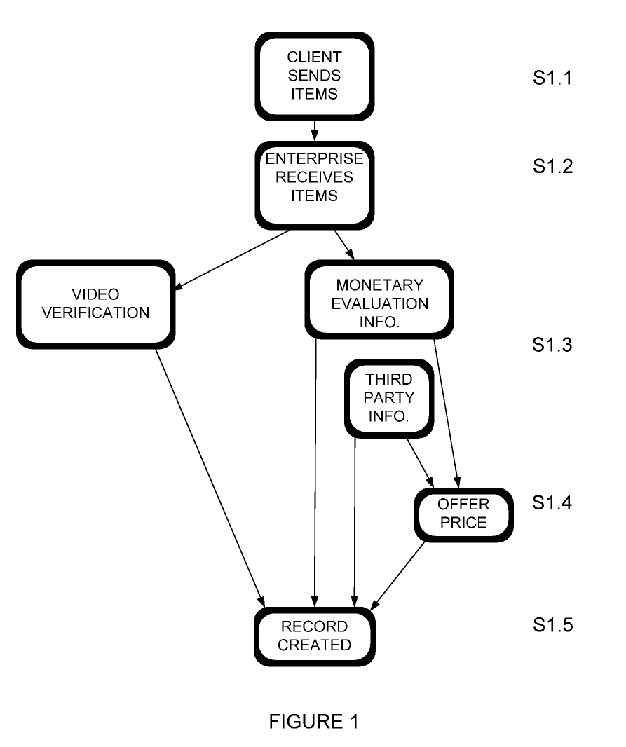

FIG. 1 displays a flowchart of a method of the present invention, according to an exemplary embodiment of the present invention. A client sends one item or a plurality of items sealed in some manner to an enterprise, S1.1, via any method appropriate for the items, including over an electronic transmission. The enterprise receives the sent items, S1.2. Upon reception of the items, the enterprise creates an inventory of the items, including video verification of the inventory of the sent items; receives a plurality of third party information regarding the items; and produces a plurality of information relevant to estimating the monetary value of the plurality of items, S1.13. In an embodiment where the plurality of items is a plurality of jewelry, such a plurality of information includes the mass and purity of each valuable component of the item. Taking the plurality of third party information and the monetary value information as inputs, an offer price for the plurality of items is created using an appropriate metric, S1.4. An electronic record, including the third party information regarding the items; the monetary value information; the offer price; and the video verification of the inventory of the items, is created and then stored in a transaction record server, S1.5. In some embodiments, the video information requires conversion to a form appropriate for the electronic record before it is included in the electronic record.

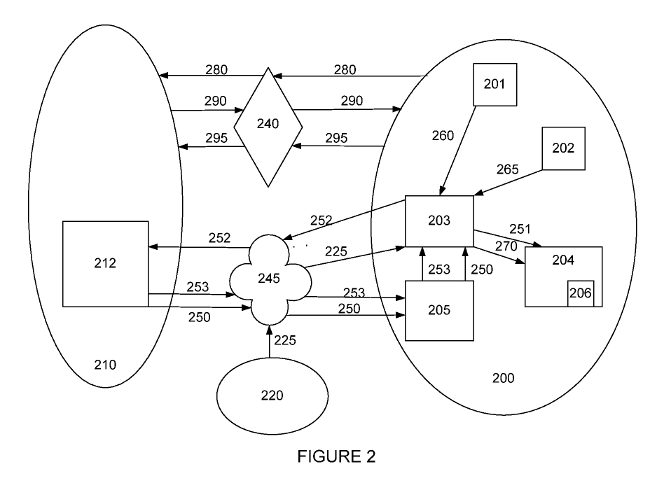

FIG. 2 displays a diagram showing the flow of goods and information between the parties and equipment of a system, according to an exemplary embodiment of the present invention. In this embodiment, there are two parties to the remote business transaction, an enterprise 200 and a client 210. Additionally, a third party 220 is present who, though not directly involved in the remote business transaction, provides third party information to enterprise 200. In an embodiment in which enterprise 200 buys precious metals from client 210, such third party information includes the current price per unit mass of precious metals. Associated with client 210 is a client computer 212. Associated with enterprise 200 are a video capture device 201, which in this embodiment is a webcam; a plurality of item monetary evaluation equipment 202; an enterprise computer 203; a transaction record server 204; and an enterprise server 205. One or more of these components (servers, etc.) may be part of and/or operated by another third party enterprise which is separate from the enterprise 200. The parties exchange goods and information through a variety of channels. In this embodiment, there is a shipping channel 240 by which the parties exchange material goods and a communications channel 245, such as the internet, by which they exchange information.

The remote business transaction begins when the client sends an account request 250 for an account with the enterprise through communications channel 245. Account request 250 includes a plurality of personal information about client 210, including a login name and password. Account request 250 is routed via enterprise server 205 to enterprise computer 203 for processing the request. In some embodiments, such processing includes making sure that client 210 does not already have an account with enterprise 200 and performing background checks, such as a criminal background check, on client 210. If enterprise 200 decides to create an account for client 210, enterprise computer 203 sends a file creation request 251 to transaction record server 204 to create a client file 206 associated with the account of client 210. Enterprise computer 203 sends an account creation notification 252 via communications channel 245 to the client stating that an account with enterprise 200 has been created for the client. The client accesses the account through communications channel 245 using the login name and password that accompanied account request 250.

Client 210, through their account with enterprise 200, sends a transaction initiation request 253 over communications channel 245 to enterprise server 205 to initiate a new remote business transaction. Enterprise server 205 forwards transaction initiation request 253 to enterprise computer 203, which generates a transaction kit 280, including a transaction identification number. Enterprise 200 sends transaction kit 280, via shipping channel 240, to client 210. Transaction kit 280 includes a seal or seals for one or a plurality of items 290. In this embodiment, such a transaction kit 280 includes a shipping container and a rules for shipping items using transaction kit 280. The transaction identification number is encoded as, for example, a barcode on the shipping container which is scanned by enterprise 200 when transaction kit 280 is received to identify transaction kit 280. Generating transaction kit 280 includes printing out a shipping label for a package delivery service with which enterprise 200 has an established account and linking the package delivery service's tracking number for the label with the transaction identification number of transaction kit 280. The tracking number serves as an identifying number for the remote business transaction. In certain embodiments, shipping channel 240 may include two or more modes of shipping, including but not limited to, U.S. Postal Services, United Parcel Service (UPS), FedEx or other known shipping companies. Any one or more shipment may use one or more shipping modes to be delivered from client 210 to enterprise 200 or vice versa.

Client 210 then seals the one or plurality of items 290 within transaction kit 280 and sends it, via shipping channel 240, to enterprise 200. Upon reception of plurality of items 290 by enterprise 200, a video capture device 201 produces a video verification of the inventory 260 of transaction kit 280 and then transfers video verification of the inventory 260 to enterprise computer 203. Video verification of the inventory 260 in this embodiment further includes video information of a return mailing address of client 210 on sealed transaction kit 280. In this manner, video verification of the inventory 260 serves to establish a clear record of what was sent by client 210. For this reason, it is important that the video information be of high enough resolution to clearly identify all of the items received in transaction kit 280. In some embodiments, enterprise 200 sends a notification (email, text, etc.) to the client 210 over communications channel 245 when transaction kit 280 is received.

Via communications channel 245, enterprise computer 203 receives a plurality of third party information 225 from third parties 220. In this embodiment, such plurality of third party information 225 is necessary for the enterprise 200 to properly fix an estimate for the monetary value of the one or plurality of items 290. For example, third party information 225 may include, but not be limited to, the market price of gold if the plurality of items is gold jewelry. Item monetary evaluation equipment 202 perform a series of measurements on plurality of items 290 and a plurality of outputs 265 of the measurements is sent to enterprise computer 203. Via a pre-determined monetary evaluation metric, enterprise computer 203 determines a plurality of estimated monetary values for each of plurality of items 290 using plurality of outputs 265 and plurality of third party information 225. Enterprise computer 203 groups the transaction identification number, plurality of outputs 265, the plurality of estimated monetary values, video verification of the inventory 260, an offer price based on the plurality of estimated monetary values, and third party information 225 together as a record 270 of the remote business transaction. Record 270 is then transferred to transaction record server 204 and stored there in client file 206. Via communications channel 245, enterprise computer 203 notifies client 210 that client file 206 associated with their account has been updated with a new remote business transaction. Thereafter, client 210 is able to view record 270 over communications channel 245 through the use of their login name and password.

Once client file 206 has been updated, enterprise 200 issues a check 295 to client 210, via shipping channel 240, for the offer price of the remote business transaction. In some embodiments, the offer price is a fixed percentage of the total of the estimated monetary values of the plurality of items. Enterprise 200 notifies client 210 via communications channel 245 that check 295 has been issued. If client 210 elects to accept check 295, client file 206 is updated to reflect the acceptance of check 295 and the remote business transaction is complete. If the client prefers to keep plurality of items 290 instead of check 295, client 210 returns check 295 via shipping channel 240 and enterprise 200 reciprocates by returning plurality of items 290 and updating client file 206 to reflect the return of plurality of items 290. In some embodiments, client 210 agrees, as part of their request for an account with the enterprise, that if check 295 is not returned to enterprise 200 within a pre-determined amount of time after client 210 receives it, enterprise 200 is not bound to return plurality of items 290. Alternatively, client 210 may select whether or not to accept the transaction via communications channel 245, such as by selecting to accept on a website. In such an embodiment, the offer price is sent to client 210 via an electronic transaction.

In an alternative embodiment, the video capture device additionally records a plurality of video information during the measurements of the plurality of item monetary evaluation equipment so that the record of the remote business transaction includes this additional video information as well. In this alternative embodiment, this additional video information is continuous in time with the video verification of the inventory of the transaction kit so that it can be established that the measured items are identical to the items removed from the transaction kit.

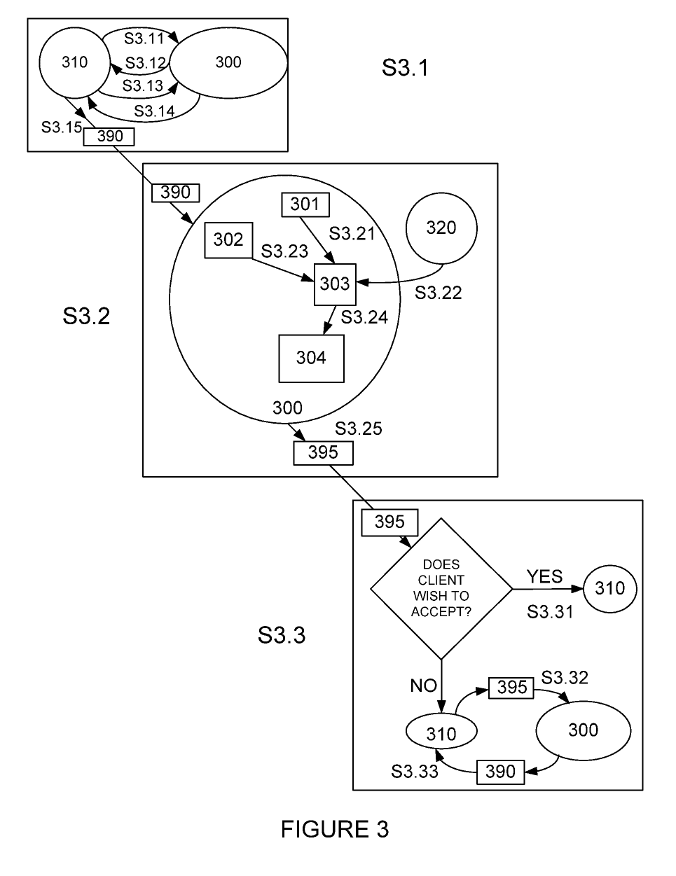

FIG. 3 displays a flowchart of the method of the present invention in which enterprise 300 buys a precious metal or stone (or any other item of value) from client 310, according to an exemplary embodiment of the present invention. Client 310 sets up a remote business transaction with enterprise 300, S3.1. Setting up a remote business transaction entails an account request, S3.11, by client 310 to enterprise 300; enterprise 300 creating an account and sending client 300 an account creation notification, S3.12; client 310 requesting a precious metal kit, S3.13; enterprise 300 sending client 310 a precious metals kit, identified by a transaction identification number, S3.14; and finally, to complete S3.1, client 310 sending a plurality of jewelry 390 packaged in the precious metal kit to enterprise 300, S3.15.

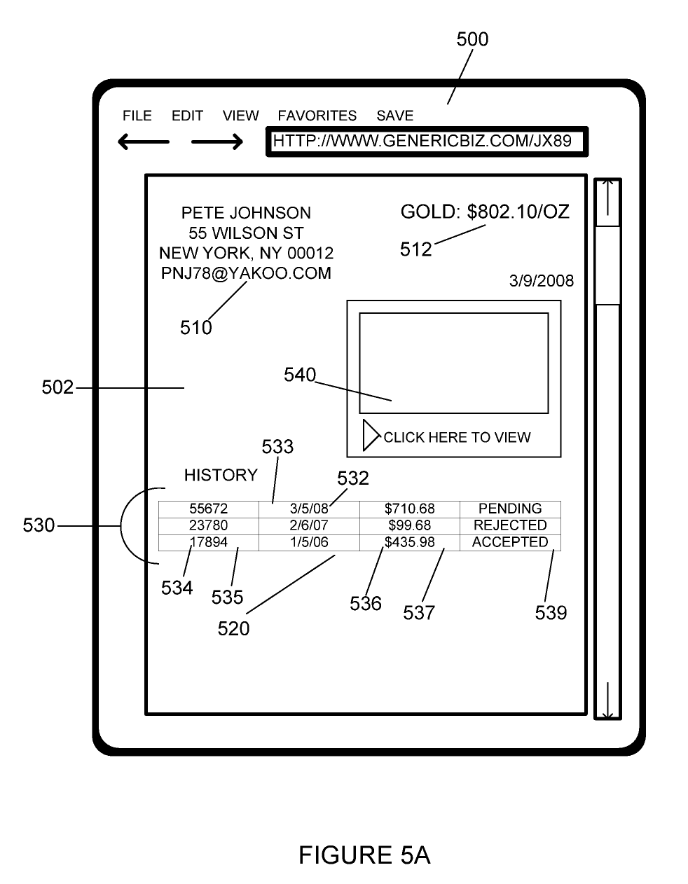

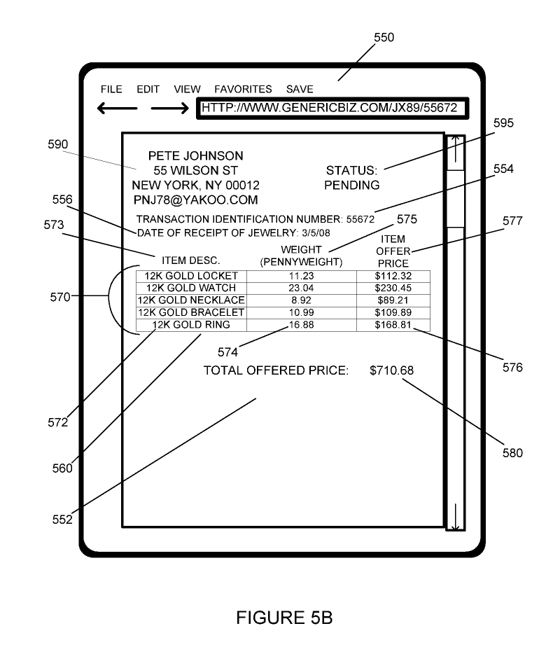

Enterprise 300 then creates a record of the remote business transaction, S3.2. Creation of such a record entails reception of a video verification of the inventory of the precious metals kit by an enterprise computer 303 from a video capture device 301, S3.21; reception of a current price of the precious metal from a third party information source 320 by enterprise computer 303, S3.22; the reception of a mass and a purity of each item of plurality of jewelry 390 by enterprise computer 303 from a plurality of mass measurement and assaying equipment 302 to calculate an offer price for plurality of jewelry 390, S3.23; and the grouping as the record and transmission to transaction record server 304 of the video verification of the inventory, the current price of precious metals, the mass and purity information, the transaction identification number, and the offer price, S3.24. To complete S3.2, enterprise 300 sends check 395 for the offer price to client 310, S3.25. In this embodiment, the offer price is determined by taking a fixed percentage of the total estimated monetary value of plurality of jewelry 390 calculated by summing, over plurality of jewelry 390, the product of the mass of each item of jewelry, the current price of the precious metal, and the purity of each item of jewelry expressed as a decimal percentage. See FIG. 5B for more detail.

Client 310 then completes the remote business transaction by accepting check 395 or having plurality of jewelry 390 returned to them, S3.3. If client 310 decides to accept check 395, client 310 keeps check 395, S3.31. If client 310 does not wish to accept the check, client 310 sends check 395 back to enterprise 300, S3.32, and enterprise 300 reciprocates by sending plurality of jewelry 390 back to client 310, S3.33.

Many alternative embodiments of the present invention are possible, all of which are within the scope of the present disclosure. In one alternative embodiment, in addition to the check, the enterprise issues a credit with the enterprise as an added inducement for the client to undertake future remote business transactions with the enterprise.

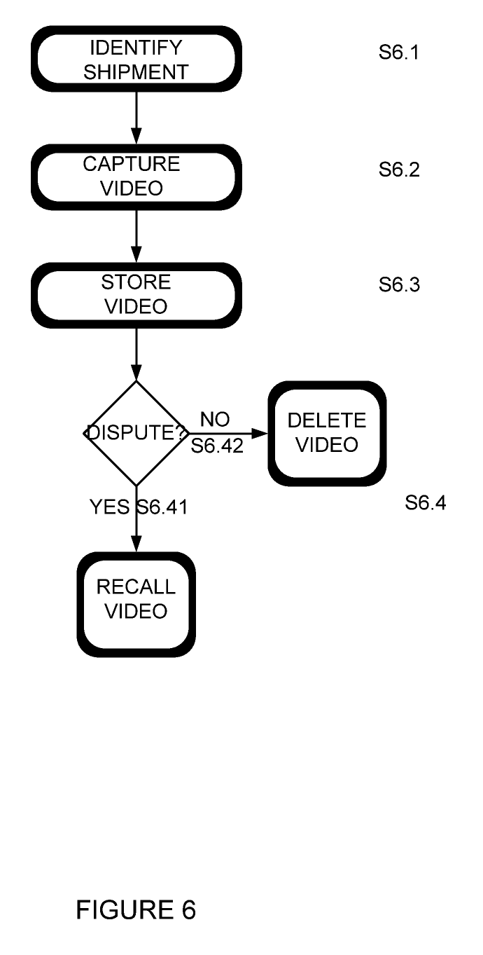

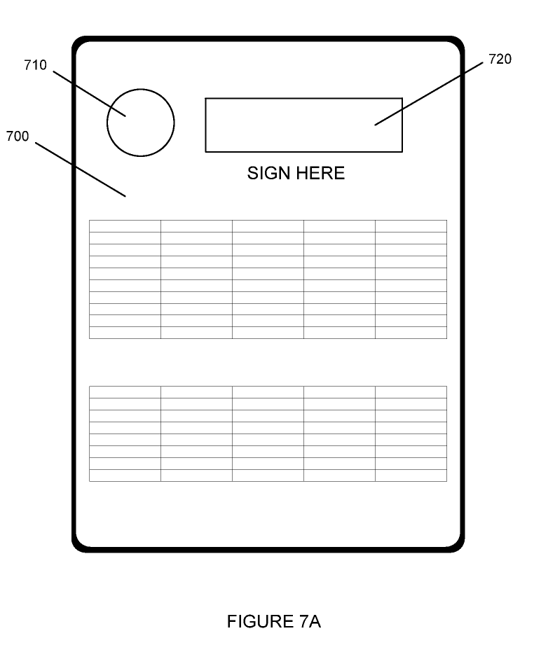

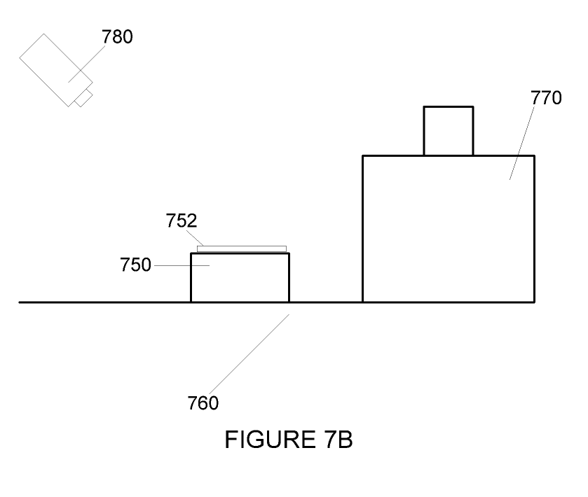

In yet another alternative embodiment of the present invention, in addition to capturing video only when the valuable item package is received by the enterprise, video information is also captured along crucial points of the delivery route from the client to the enterprise. For example, video of the valuable item package is taken every time the package changes custody or arrives at a new node in its route from the client to the enterprise, or from any one location to another. For instance, video is taken when the package enters a package sorting facility from a freight train, in transfer between the sorting facility and delivery truck, and at delivery by the truck to the enterprise. Such embodiment has broad applications to shipment companies which ship thousands of items per day, insurance companies which must insure the safe delivery of such items, enterprises who rely on safe delivery of the items to a customer, and customers who rely on safe receipt of such items. One or more such interested parties could log into and view the package as it traverses and passes by such video monitoring locations wherein each such party can determine a visual appearance and condition of such package as it traverses such location. For example, if an expensive item of art is shipped from China to an art collector in New York City, and the art is damaged upon receipt by the collector, use of the present embodiment allows all interested parties to view the condition of the package as it traverses such video monitoring posts to determine exactly when such damage could have been done. Such information may be valuable in terms of liability and insurance. This example is also applicable to all shipments made in the United States, as such “video monitoring” may be presented as an optional paid service to monitor packages which the sender or recipient wants additional assurance of its condition upon delivery. See FIGS. 6, 7A and 7B for more details.

In an alternative embodiment of the present invention, in addition to video verification of the inventory of the precious metals kit, video capture device also records video information of the process of measuring the mass and purity of each item of jewelry in the precious metals kit and transfers this video to the enterprise computer for inclusion in the record. In this alternative embodiment, such video information is continuous in time with the video verification of the inventory of the precious metals kit so that it can be established that the measured plurality of jewelry are identical to the plurality of jewelry removed from the precious metals kit. In a further alternative embodiment, the video capture device displays a time and date stamp; the transaction identification number as a stamp; and the mass of each item of jewelry as a stamp in all video files sent to the enterprise computer.

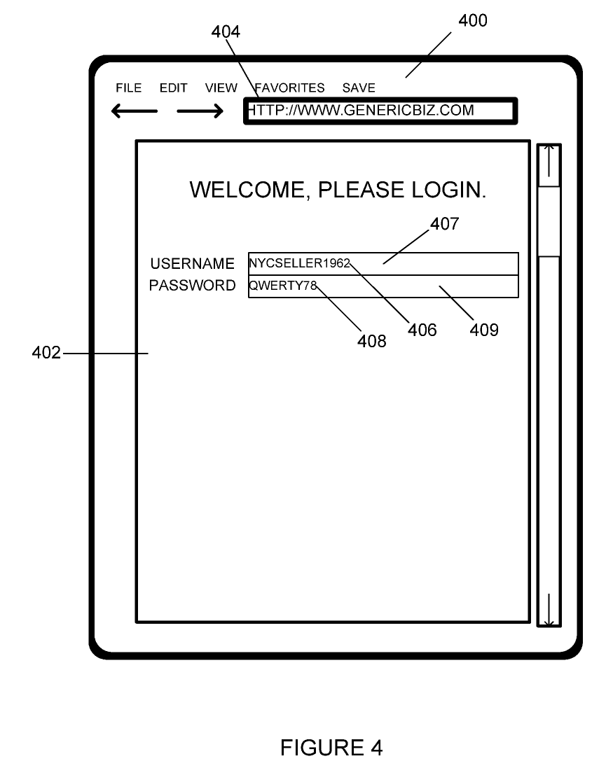

FIG. 4 displays a screenshot of a web browser 400 showing a login page 402 of a website of the enterprise in which the enterprise buys precious metals from the client, according to an exemplary embodiment of the present invention. Associated with the website is a web address 404. A user of browser 400 enters a client login name 406 in a login name field 407 and a password 408 in a password field 409. If client login name 406 and password 408 match a client login name and password stored on the enterprise server, then the user is allowed to access the electronic records of all of the remote business transactions associated with the corresponding client account.

FIG. 5A displays a screenshot of a web browser 500 showing a client view of a transactions page 502 associated with a client account in an embodiment of the present invention in which the enterprise buys precious metals from the client. A plurality of client personal information 510 associated with the client account is displayed on transaction page 502. Additionally, a current price of gold 512 on the London Gold Exchange is displayed on transaction page 502. A history chart 520 listing all remote business transactions between the client and the enterprise is displayed on transaction page 502. History chart 520 is composed of a plurality of transaction records 530, each of which is associated with a different remote business transaction between the enterprise and the client. In this embodiment, each remote business transaction entails an offer by the enterprise to buy a plurality of jewelry from the client. Each transaction record 530 is divided into a transaction date field 533 showing a date 532 of its associated remote business transaction; a transaction identification number field 535 showing a transaction identification number 534 of its associated remote business transaction; an offered price field 537 showing an offered price 536 of its associated remote business transaction; and a transaction disposition field 539 indicating if offered price 536 was accepted by the client, rejected by the client, or if the decision is still pending. In some embodiments, each transaction record 530 is associated with a link, from which, if selected by a user of browser 500, for example, by clicking on the link, a pop-up window appears with an inventory of the plurality of jewelry of the associated remote business transaction and a price offered for each item of the plurality of jewelry. Each item of the inventory is identified by a description and a photo of the item. In some further embodiments, the pop-up window includes a link to a plurality of video information associated with the transaction. Transaction page 502 includes a video window 540 displaying all video information associated with the most recent remote business transaction between the client and the enterprise. In this embodiment, the video information includes video verification of the inventory of a sealed precious metals kit identified by a transaction identification number.

In an alternative embodiment of the present invention, for any pending remote business transactions, the client selects, from the inventory of the plurality of jewelry appearing in the pop up window, which items of the inventory he/she wants returned, so that the client has the ability to choose, not simply whether or not to accept the check for the offered price, but which items of the plurality of jewelry specifically to sell.

FIG. 5B displays a screenshot of a web browser 550 showing a client view of an inventory page 552 of a remote business transaction between the enterprise and the client, according to an exemplary embodiment of the present invention. In this embodiment, the remote business transaction entails an offer by the enterprise to buy a plurality of jewelry from the client based on a precious metal or stone content of the plurality of jewelry. Each of the transaction records of a transactions page, such as the transactions page displayed in FIG. 5A, links to such an inventory page 552. Thus, the user of web browser 550 has the ability to access inventory page 552 by “clicking” (i.e., loading the link via a graphical user interface and the action of a user input device, such as a mouse) on the associated transaction record of the transaction page. Inventory page 552 includes a transaction identification number 554 of the remote business transaction and a date of receipt 556 showing the date on which the enterprise received the plurality of jewelry from the client in the remote business transaction. Inventory page 552 includes an inventory 560 of the plurality of jewelry sent by the client to the enterprise in the remote business transaction. Inventory 560 is composed of a plurality of item records 570, each corresponding to an item received in the plurality of jewelry sent by the client to the enterprise. Each item record 570 is divided into an item description field 573 containing an item description 572; a weight field 575 showing a mass 574 of the item; and an item offer price field 577 showing an item offer price 576. In this embodiment, item description 572 includes a precious metal purity of the item, measured in carats; mass 574 of the item, measured by a jewelry scale in pennyweights; and item offer price 576, determined by multiplying the precious metal purity of the item expressed as a decimal by mass 574 and by a fixed percentage of the price per pennyweight of the precious metal. Inventory page 552 includes an offered price 580 which is the sum of all item offer prices 576 and which corresponds to the dollar amount the enterprise offers for the plurality of jewelry sent by the client to the enterprise. Additionally, inventory page 552 displays a transaction disposition 595, indicating if offered price 580 was accepted, rejected, or if the completion of the associated remote business transaction is still pending and a plurality of client personal information 590 for the client of the remote business transaction.

FIG. 6 displays a flowchart of the method of an alternative embodiment of the present invention. This embodiment broadens the use of the techniques of the method outlined previously in FIG. 1 to accommodate other contexts in which the use of video information has the ability to resolve disputes regarding a plurality of items that is shipped. The shipment of the plurality of items is identified at some point in its transit, S6.1. In some embodiments, such an identity corresponds to a package tracking number of the shipment of the plurality of items. Note that this identity serves to identify the shipment of the plurality of items, not necessarily the plurality of items themselves. A plurality of video information is then captured regarding the status of the plurality of items at this point in its transit, S6.2. Depending on the specific application of the method, such a status refers to different aspects of the shipment of the plurality of items at the point at which the video information is captured. In one embodiment of this method, this status refers to the integrity of the seal holding the plurality of items in place. In a different embodiment of this method, this status refers to the integrity of the plurality of items themselves. In a different embodiment of this method, this status refers to the delivery of the plurality of items to the party to whom it is addressed, as a plurality of video information is captured showing the person who signs for the plurality of items. Following this, the plurality of video information is stored along with the identity of the shipment and a plurality of other properties of the shipment at this point in its transit, S6.4. In some embodiments of this method, such other properties include the time and date at which the video information was captured. Then, the plurality of video information is recalled or disposed of, S6.4. If at some later time, there is a dispute regarding the plurality of items in shipment, the plurality of video information is recalled to see if it resolves the dispute, S6.41. For example, such a dispute could be in regard to damage to the plurality of items while it is in transit or in regard to whether or not the plurality of items was delivered to the right address. If, after some fixed amount of time, no dispute regarding the plurality of items has occurred, the plurality of video information is erased, S6.42, or saved in an archived database (not shown).

FIGS. 7A and 7B show two user cases utilizing the method of the alternative embodiment of the present invention outlined in FIG. 6, according to exemplary embodiments of the present invention. In FIG. 7A, a delivery clipboard 700 is equipped with a small video camera 710 and an electronic signature block 720. When delivery personnel deliver a shipment to the party to whom it is addressed, a plurality of video information is taken of the person signing electronic signature block 720 while they sign it and/or of the package upon delivery. In this manner, clear visual proof is stored which shows who signed for the shipment and the condition of the package upon delivery.

In FIG. 7B, a package 750 has just arrived at a package video monitoring location 760, which could be, but is not limited to, a transition point in the delivery route of any package 750. Such transitions points can be, for example, a particular transit location in a sorting facility, delivery truck, train, or other designated location. Package 750 includes an identifying element 752. In some embodiments, such an identifying element is a barcode coded with the tracking number of the package. In some embodiments, such an identifying element is an RFID chip broadcasting the tracking number. Package 750 enters a package identifier 770. Package identifier 770 interacts with identifying element 752 to learn the identity of package 750, then stores the identity and the time at which package 750 entered package identifier 770. In some embodiments, package identifier 770 is a barcode scanner. In other embodiments, package identifier 770 is an RFID reader. While package 750 enters package identifier 770, a video camera 780 captures and stores a plurality of video information about the external condition of package 750. Video camera 780 is of high enough resolution to read the address written on package 750 and show if there are any defects in the outside of package 750. For example, video from video camera 780 shows if package 750's seal has been broken or if the package has been punctured or deformed. Additionally, video camera 780 places a time and date stamp on all the video information it captures. In this manner, clear visual proof is stored which shows the integrity of package 750 at the point at which it arrives at package video monitoring location 760. If at some later time it is desired to review the state of package 750 at the time it entered package video monitoring location 760, the user simply has to search the stored records of package identifier 770 to learn when package 750 entered package video monitoring location 760 and then review all video information captured by video camera 780 at that time. In some embodiments, video camera 780 may be positioned within package identifier 770.

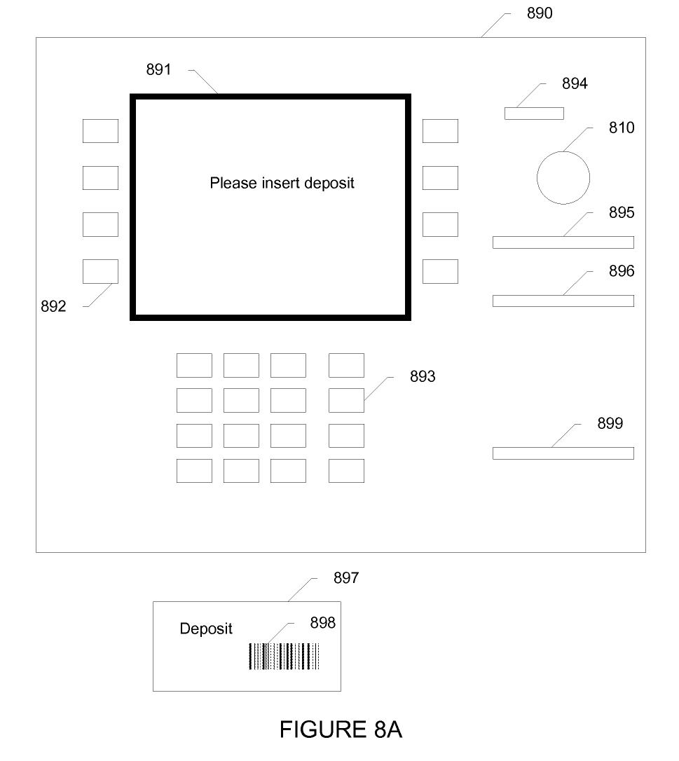

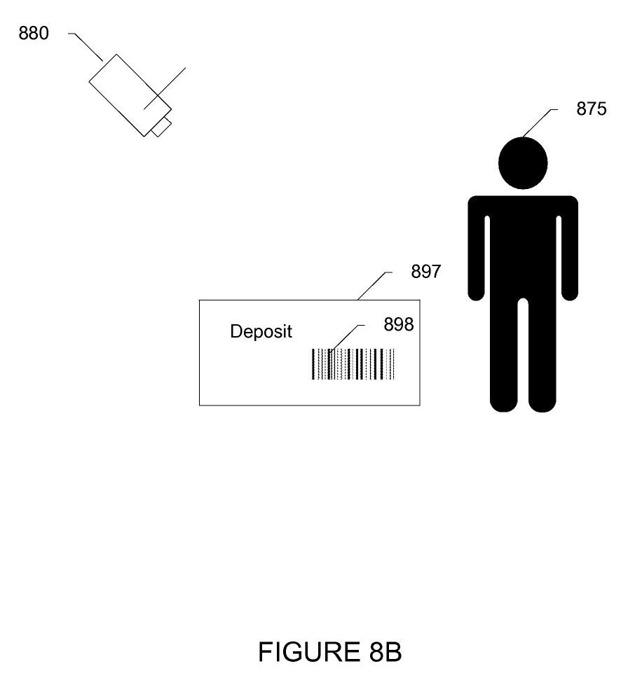

FIGS. 8A and 8B show the present invention utilized in conjunction with a conventional automated teller machine (ATM), according to an exemplary embodiment of the present invention. In this embodiment, cameras are used to track the actions of an ATM user making a deposit in an envelope and/or a bank official opening the deposit envelope. This embodiment is useful to ensure that all deposits made are accounted for by the bank.

FIG. 8A shows an ATM machine 890 with a camera 810 to track the actions of an ATM user, according to an exemplary embodiment of the present invention. In this embodiment, ATM 890 includes a display 891, screen selection keys 892, a keypad 893, a bank card slot 894, a camera 810, a deposit slot 895, a receipt slot 896, and a cash slot 899. Also shown is a deposit envelope 897 with a unique barcode 898. The ATM user inserts a bank card into bank card slot 895 and enters the passcode into keypad 893. Camera 810 is positioned such that it can be turned on and angled to record various information of the user after the user enters the passcode to activate the account and transaction. Using screen select keys 892 corresponding to options on display 891, the user selects the type of desired transaction to proceed with. When the user selects to make a deposit, camera 810 focuses on deposit slot 895. Camera 810, or a combination of cameras, can focus on the ATM user, keypad 893, deposit slot 895, receipt slot 896, cash slot 899, or any other feature of ATM 890 during this or any transaction. The ATM user places the cash and/or check(s) into deposit envelope 897 and seals deposit envelope 897. The ATM user inserts deposit envelope 897 into deposit slot 895. Camera 810 records this action as well as unique barcode 898 on deposit envelope 897. Alternatively, a scanner in deposit slot 895 scans unique barcode 898. ATM 891 prints a receipt for the transaction at receipt slot 896. If the user selects to receive cash back, the cash is received through cash slot 899.

FIG. 8B shows the receipt of deposit envelope 897 and the opening of deposit envelope 897 by a bank employee 875, according to an exemplary embodiment of the present invention. Similar to other embodiments, bank employee 875 opens the seal of deposit envelope 897 in front of camera 880. Camera 880 is able to see whether the seal is intact at this opening or whether it has already been breached. Camera 880 records this act as well as unique barcode 898 and the amount of the cash and checks removed from deposit envelope 897. The cash may be counted manually or using conventional cash counting machines, all as recorded by camera 880. This ensures that all deposits are accounted for. Any videos or pictures taken are stored for later verification. The user may then access such video accounts of the opening of the deposit envelope based on the user's account with the bank or financial institution and accessing the particular video clip associated with a particular AT transaction. Conversely, the bank or financial institution may access the video clip of the user depositing the envelope into the ATM.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of generating a record of a remote business transaction comprising:
receiving one or more items which are in a sealed container;
opening the sealed container;
performing a video verification of an inventory of the items;
estimating a monetary value of the items;
calculating an offer price based the monetary value of the items; and
grouping the video verification of the inventory of the items and the offer price as the record of the remote business transaction.

2. The method of claim 1, wherein the remote business transaction is associated with a transaction identification number included in the record of the remote business transaction.

3. The method of claim 1, wherein video information of measurements of the items is included in the record of the remote business transaction.

4. The method of claim 3, wherein, on a route taken by the items which are sealed as they move from the sender to the recipient, a video capture device, placed at a point on the route at which the items which are sealed experience a change in custody, captures a video information about a status of the items which are sealed.

5. The method of claim 3, wherein video information of the record of the remote business transaction includes a time and date stamp; a transaction identification number stamp; and a stamp of a result of one of the measurements.

6. The method of claim 1, wherein a recipient of the items which are sealed has a website and a sender of the items has the ability to view the record of the remote business transaction by entering a login name and password on a login page of the website.

7. The method of claim 6, wherein the recipient of the items which is sealed is an enterprise which buys a precious metal and the items include jewelry.

8. The method of claim 7, wherein performing an estimation of the monetary value of the jewelry comprises:
receiving a current price of the precious metal;
for each item of jewelry, measuring a mass and a purity of the item of jewelry and multiplying the current price, the mass of the item of jewelry, and the purity of the item of jewelry as an estimated monetary value of the item of jewelry; and
taking the sum of the estimated monetary value of each item of jewelry over the complete set of jewelry.

9. The method of claim 8, wherein third party information is used to undertake the estimating of the monetary value of the items.

10. A system of generating a record of a remote business transaction involving one or more items which are sealed, comprising:
a video capture device;
a logic on a computer readable medium to implement a monetary evaluation metric; and
a transaction record server,
wherein the video capture device captures a video verification of an inventory of items; the logic to implement a monetary evaluation metric determines an offer price for the items; and the offer price for the items and the video information are grouped as the record of the remote business transaction on the transaction record server.

11. The system of claim 10, wherein the remote business transaction is associated with a transaction identification number included in the record of the remote business transaction.

12. The system of claim 10, wherein video information of measurements of the items is included in the record of the remote business transaction.

13. The system of claim 12, wherein a recipient of the items which are sealed has a website and a sender of the items has the ability to view the record of the remote business transaction by entering a login name and password on a login page of the website.

14. The system of claim 13, wherein the recipient of the items which are sealed is an enterprise which buys a precious metal and the items include jewelry.

15. The system of claim 14, wherein third party information is used as an input to the monetary evaluation metric.

16. The system of claim 15, wherein the input to the monetary evaluation metric comprise:
a current price of the precious metal; and
for each item of jewelry, a mass and a purity.

17. The system of claim 16, wherein the monetary evaluation metric comprises:
a summation, over the jewelry, of a product of the mass, the purity, a fixed decimal percentage, and the current price of the precious metal.

18. The system of claim 17, wherein the recipient of the jewelry has disclosed to the sender of the jewelry the current price of the precious metal before the jewelry is sent.

19. The system of claim 13, wherein, on a route taken by the items which are sealed as they move from the sender to the recipient, a video capture device, placed at a point on the route at which the items which are sealed experience a change in custody, captures video information about a status of the items which are sealed.

20. The system of claim 19, wherein the video information of the record of the remote business transaction includes a time and date stamp; a transaction identification number stamp; and a stamp of a result of one of the measurements.
